(19) United States
(12) Patent Application Publication
(10) Pub. No.: US 2002/0067046 A1
(43) Pub. Date: Jun. 6, 2002

(54) Drop lock-outward opening door retaining device

(76) Inventor: James Neiland Cox SR., Sanger, TX (US)

Correspondence Address: JAMES NEILAND COX, SR, 818 VERNON CT, SANGER, TX, 76266, US

(21) Appl. No.: 09/729,679

(22) Filed: Dec. 5, 2000

(51) Int. Cl. E05C 19/18

(52) U.S. Cl. 292/289

(57) ABSTRACT

An apparatus for enhancing the security of an outward opening door or a door opening into another room in which the door knob and the door jamb face are utilized by the apparatus to facilitate the retention of the door. The use of various materials and applications provides versitility to the concept utilized in the spirit and scope of the invention.

### BACKGROUND OF THE INVENTION

The invention relates to securing an outward opening door to supplement the internal locking devices furnished with the door.

Outside doors are usually furnished with a dead bolt lock and a keyhole knob lock. Both of these locking mechanisms depend on a bolt that enters the door jamb. Most door jambs are made of wood; both can be picked, a skeleton key used, or the door can be pried open. This device is intended primarily for manufactured housing since the rear, or back door, opens outward. However, the device can be used on any outward opening door or on a door opening into another room.

### SUMMARY OF THE INVENTION

The present invention is a simple and effective means to enhance the security for manufactured homes. The device utilizes the existing knob and the door frame to retain the door. There are no holes to be drilled or hardware to attach to either the door or the door jamb. The device is simply dropped over the door knob neck and the configuration and the door knob holds the device in place and secures the door utilizing the knob and the jamb face from the outside without the removal of the knob on the inside of the structure. The device is adjustable to allow for variations in the location of the knob in relation to the jamb and variations in the knob to jamb face.

No tools are required for adjusting the device other than a coin or screw driver to move the screws for custom fitting against the jamb. The use and simplicity of the device have been set forth in the accompanying drawings.

### BRIEF DESCRIPTION OF THE DRAWINGS

A more complete understanding of the invention can be obtained by considering the following detailed description in conjunction with the following drawings, in which:

FIG. 1 is an isometric view of the invention with the spacer (14) and in one of the adjustable positions.

FIG. 2 is a top view of the invention installed on an outward opening door.

FIG. 3 is a front view of the invention installed on a door and the knob removed for clarity.

FIG. 4 is a right profile (side) view of the invention with the spacer (14) in place:

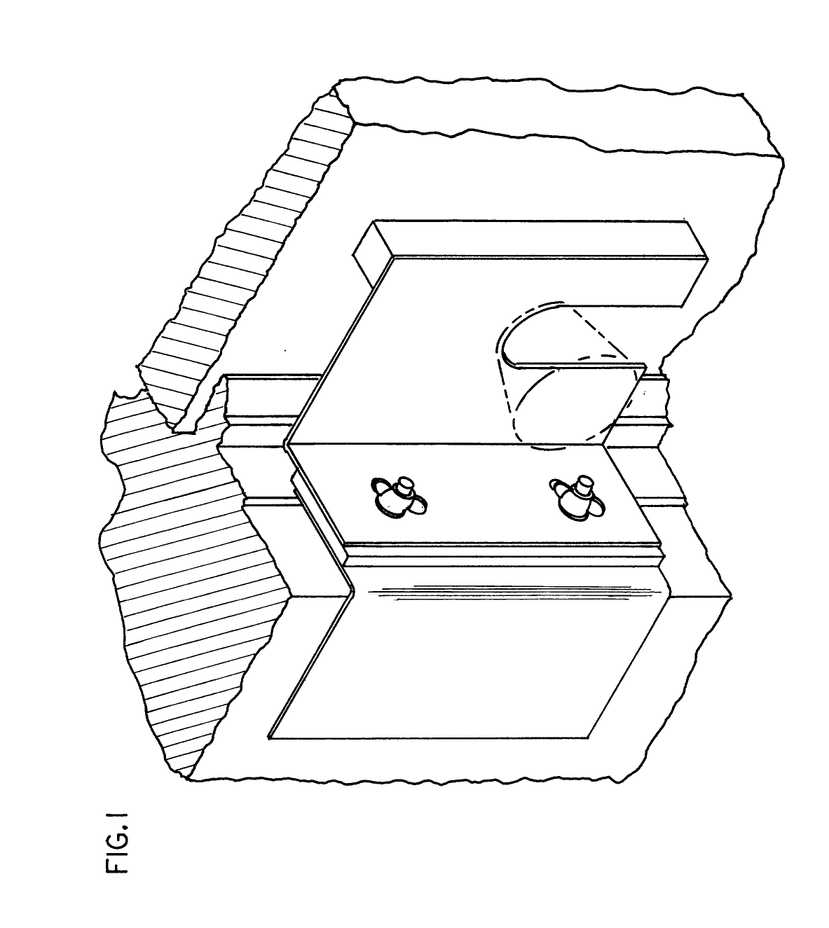

### DETAILED DESCRIPTION OF THE PREFERRED EMBODIMENT

Reference will now be made in detail to the present preferred embodiment of the invention, an example of which is illustrated in the accompanying drawings, while the invention will be described in connection with a preferred embodiment, it will be understood that it is not intended to limit the invention to that embodiment. On the contrary, it is intended to cover all alternatives, modifications, and equivalents as may be included within the spirit and scope of the invention defined in the approved claims.

Positioned upon the knob neck (17) is shown the knob latch bracket (13). The knob latch bracket (13) is secured to the jamb bracket (12) utilizing machine screws (11). A spacer (14) may be used to compensate for variations in home manufacturing tolerance.

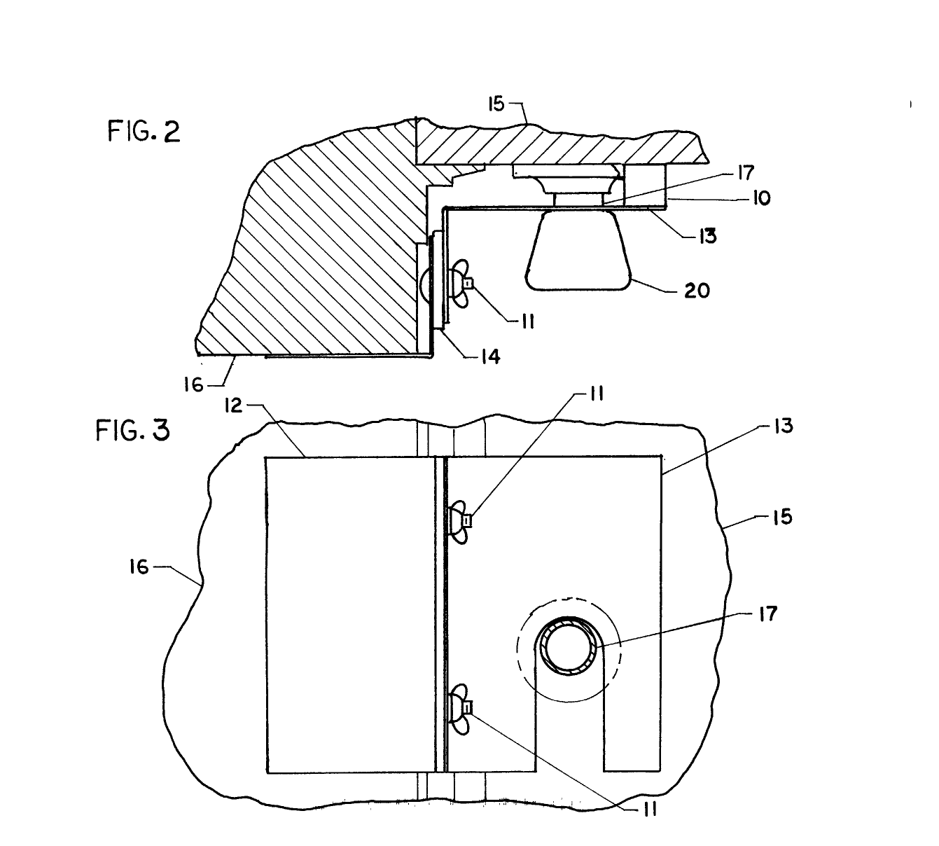

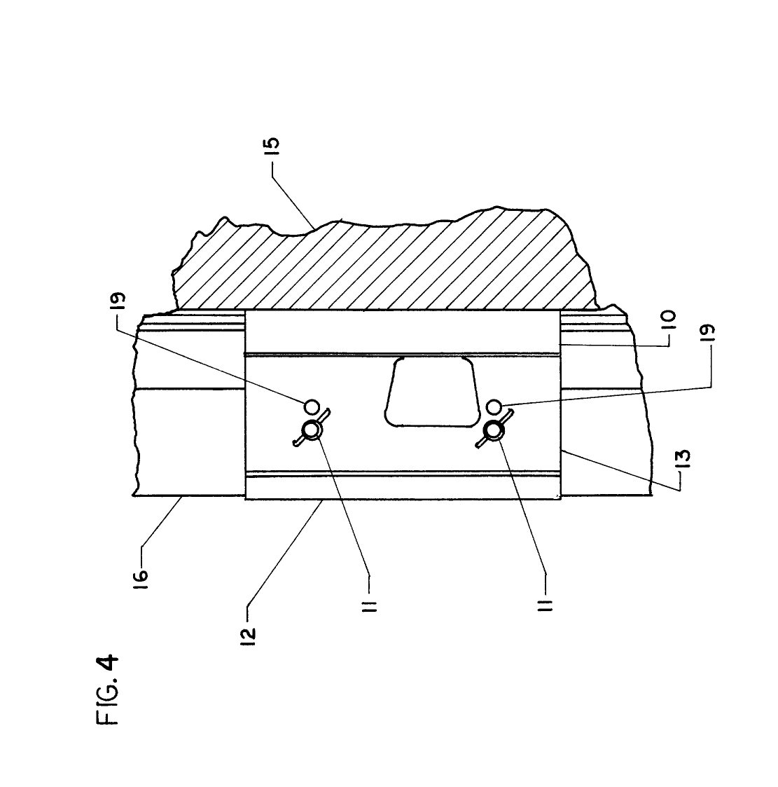

Detailed in FIG. 2 is a top view of the invention (18) installed on the knob (17) and retained by the jamb face (16). Positioned on the knob (17) is the knob latch bracket (13). The knob latch bracket (13) is secured to the jamb bracket (12) utilizing a plurality of machine screws (11). The spacer (14) may be used to coompensate for variations in home manufacturing tolerances. There are multiple sets of holes (19) that are used to compensate for home manufacturing tolerances.

What is claimed is:

1. An outward opening door security assistance apparatus to enhance the security of said door from being opened from the outside, the apparatus comprising a retaining member, said member having a slot that drops over the knob neck and is of such dimension that it will not pass over the knob, and effectively secures the knob. The additional member, the jamb bracket, is securely attached to the slotted member, utilizing the knob latch bracket, and cannot fall from it in intended position nor prevent the apparatus from fulfilling its intended purpose of restraining the door.

2. The spacer/buffer (10) is attached to the knob latch bracket (13) is of a compressible material to insure a good fit with the door face and to apply pressure to the knob latch bracket to position said bracket against the knob.

3. The knob latch bracket is attached to the jamb bracket utilizing a plurality of machine screws and the jamb bracket is to be positioned such that the inside face of said back and comes in contact with the face of the door jamb.

4. The plurality of screw holes are utilized to facilitate adjustment of jamb bracket to compensate for manufacturing variation in manufactured housing construction

5. The use of the spacer will depend upon the dimensional variations between the inside of the door jamb and the knob.
